(19) United States
(12) Patent Application Publication
(10) Pub. No.: US 2026/0246700 A1
(43) Pub. Date: Aug. 20, 2026

(54) SYSTEM AND METHOD FOR PROVIDING BINDING SUPPORT FUNCTION IN A NETWORK

(71) Applicant: JIO PLATFORMS LIMITED, Ahmedabad, Gujarat (IN)

(72) Inventors: Aayush BHATNAGAR, Navi Mumbai, Maharashtra (IN); Mukta SHETTY, Thane, Maharashtra (IN); Milan Kumar KALAVADIYA, Jamnagar, Gujarat (IN); Yugandhara JOSHI, Amravati, Maharashtra (IN)

(73) Assignee: JIO PLATFORMS LIMITED, Ahmedabad, Gujarat (IN)

(21) Appl. No.: 18/992,622

(22) PCT Filed: Feb. 16, 2024
(86) PCT No.: PCT/IN2024/050161

§ 371 Date: Jan. 9, 2025

(30) Foreign Application Priority Data
Feb. 17, 2023 (IN) 202321010721

(51) Int. Cl. H04L 41/0894

(52) U.S. Cl. CPC H04L 41/0894

(57) ABSTRACT

The disclosed system and method are configured to perform functionalities for providing a Binding Support Function (BSF) (2000). The BSF (2000) is a network entity in a 5G Core Network (5GC) and stores binding information for a certain Protocol Data Unit (PDU) session and enables discovery of binding information (e.g., the address information of a selected Point coordination function (PCF) (1508).

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of wireless networks, and specifically to a system and a method for performing functionalities of a Binding Support Function (BSF).

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

5G/New Radio (5G/NR) is a next generation global wireless standard. The 5G/NR provides various enhancements to wireless communications, such as providing flexible bandwidth allocation, improved spectral efficiency, ultra-reliable low-latency communications, beamforming, high-frequency communication. For providing these enhancements and for efficient working of the network, specialized functions for integration of network elements are required.

There is, therefore, a need in the art for an improved system and method that effectively provides binding support functions for efficient working of the network.

### SUMMARY

In an exemplary embodiment, a binding support function (BSF) for providing binding support management service is described. The BSF is configured to receive a binding information of a packet data unit (PDU) session for a user equipment (UE) from a policy control function (PCF). The binding information includes at least one of a user identity, a data network name (DNN), a user equipment (UE) internet protocol (IP) address, network slice for the PDU session. The BSF is further configured to create a PCF session binding resource to store the binding information of the PDU session for the UE. The BSF is configured to send a response message having a representation of the created binding information to the PCF and enable discovery of binding information. For enabling discovery of binding information, the BSF is configured to receive a http request message with query parameters from the PCF. The query parameters include UE address, subscription permanent identifier (SUPI)/generic public subscription identifier (GPSI), data network name (DNN), single-network slice selection assistance information (S-NSSAI), IPv4 address domain. The BSF is configured to match information stored in the session binding resource with at least one of the query parameters. The BSF is configured to send a response message containing the binding information to the PCF on determining that query parameters are matched with the session binding resource.

In some embodiment, the BSF is configured to send “no content” message to the PCF on determining that query parameters are not matched with the session binding resource.

In some embodiments, the BSF is configured to integrate with network functions (NFs) for a hypertext transfer protocol-2 (HTTP2) based interfaces directly or via a service communication proxy (SCP).

In some embodiments, the BSF is configured to act as a proxy to redirect the UE to the PCF based on an internet protocol (IP) address of the UE.

In some embodiments, plurality of BSF service managers is deployed using an active/standby/spare architecture to provide a high available cluster.

In another exemplary embodiment, a system for providing binding support management service is described. The system comprises binding support function (BSF). The BSF comprising a receiving module configured to receive a binding information of a packet data unit (PDU) session for a user equipment (UE) from a policy control function (PCF). The binding information includes a user identity, a data network name (DNN), a user equipment (UE) internet protocol (IP) address, network slice for the PDU session. A processing module configured to create a PCF session binding resource to store the binding information of the PDU session for the UE. A sending module configured to send a response message having a representation of the created binding information to the PCF. The processing module configured to enable discovery of binding information. For enabling discovery of binding information, the receiving module configured to receive a http request message with query parameters from the PCF. The query parameters include UE address, subscription permanent identifier (SUPI)/generic public subscription identifier (GPSI), data network name (DNN), single-network slice selection assistance information (S-NSSAI), IPv4 address domain. The processing module configured to match information stored in the session binding resource with at least one of query parameters. The sending module configured to send a response message containing the binding information to the PCF on determining that query parameters are matched with the session binding resource.

In some embodiment, the sending module configured to send “no content” message to the PCF on determining that query parameters are not matched with the session binding resource.

In some embodiments, the BSF is configured to integrate with network functions (NFs) for a hypertext transfer protocol-2 (HTTP2) based interfaces directly or via a service communication proxy (SCP).

In some embodiments, the BSF is configured to act as a proxy to redirect the UE to the PCF based on an internet protocol (IP) address of the UE.

In some embodiments, plurality of BSF service managers is deployed using an active/standby/spare architecture to provide a high available cluster.

In yet another exemplary embodiment, method for providing binding support management service is described. The method includes receiving, by a binding support function (BSF), a binding information of a packet data unit (PDU) session for a user equipment (UE) from a policy control function (PCF). The binding information includes a user identity, a data network name (DNN), a user equipment (UE) internet protocol (IP) address, network slice for the PDU session. The method further includes creating, by the BSF, a PCF session binding resource to store the binding information of the PDU session for the UE. The method includes sending, by the BSF, a response message having a representation of the created binding information to the PCF and enabling, by the BSF, discovery of binding information. The method further includes receiving, by the BSF, a http request message with query parameters from the PCF. The query parameters include at least one of UE address, subscription permanent identifier (SUPI)/generic public subscription identifier (GPSI), data network name (DNN), single-network slice selection assistance information (S-NSSAI), IPv4 address domain. The method includes matching, by the BSF, information stored in the session binding resource with at least one of query parameters. The method further includes sending, by the BSF, a response message containing the binding information to the PCF on determining that query parameters are matched with the session binding resource and

In some embodiment, the method further comprises on determining that query parameters are not matched with the session binding resource, sending, by the BSF, “no content” message to the PCF.

In some embodiments, the BSF is configured to integrate with network functions (NFs) for a hypertext transfer protocol-2 (HTTP2) based interfaces directly or via a service communication proxy (SCP).

In some embodiments, the BSF is configured to act as a proxy to redirect the UE to the PCF based on an internet protocol (IP) address of the UE.

In some embodiments, plurality of BSF service managers is deployed using an active/standby/spare architecture to provide a high available cluster.

Other objects and advantages of the present disclosure will be more apparent from the following description, which is not intended to limit the scope of the present disclosure.

### Objects of the Present Disclosure

It is an object of the present disclosure to provide a system and a method to perform functionalities of a Binding Support Function (BSF).

It is an object of the present disclosure to provide the BSF that stores binding information for a particular Protocol Data Unit (PDU) session and enables discovery of binding information.

It is an object of the present disclosure to provide a BSF design having high resilience and scalability.

It is an object of the present disclosure to provide the BSF such that there is no single point of failure which includes node level redundancy, network redundancy and geo-redundancy.

It is an object of the present disclosure to provide minimal latency and packet loss under load condition in a wireless network.

It is an object of the present disclosure to integrate the BSF with other network functions via Hyper Text Transfer Protocol 2 (HTTP2) based interfaces both directly and via a Service Communication Proxy (SCP).

It is an object of the present disclosure to enable providing a separate Session Database Layer (SDL) to provide session data across multiple sites for geo-redundancy.

It is an object of the present disclosure to deploy the BSF in active, hot standby, and spare manner across the wireless network.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an internal cluster architecture of a Binding Support Function (BSF), in accordance with an embodiment of the present disclosure.

FIG. 2 illustrates an exemplary deployment architecture of a system executed by a processor k, in accordance with an embodiment of the present disclosure.

FIG. 3 illustrates an exemplary NRF registration for enabling an NF instance to register its NF profile in the NRF, in accordance with an embodiment of the present disclosure.

FIG. 4 illustrates an exemplary mechanism, where the NF instance completely updates parameters of the NF profile in the NRF, in accordance with an embodiment of the present disclosure.

FIG. 5 illustrates an exemplary mechanism, where the NF instance partially updates parameters of the NF profile in the NRF, in accordance with an embodiment of the present disclosure.

FIG. 6 illustrates an exemplary mechanism showing NF Heart-Beat, in accordance with an embodiment of the present disclosure.

FIG. 7 illustrates an exemplary mechanism showing how service operation removes a profile of the NF previously registered in the NRF, in accordance with an embodiment of the present disclosure.

FIG. 8 illustrates an exemplary mechanism showing NFStatusSubscribe, in accordance with an embodiment of the present disclosure.

FIG. 9 illustrates an exemplary mechanism showing NF StatusUnSubscribe, in accordance with an embodiment of the present disclosure.

FIG. 10 illustrates an exemplary mechanism showing NFStatusNotify, in accordance with an embodiment of the present disclosure.

FIG. 11 illustrates an exemplary mechanism showing registration of a new PCF session binding information, in accordance with an embodiment of the present disclosure.

FIG. 12 illustrates an exemplary mechanism showing deregistering of an individual PCF session binding information, in accordance with an embodiment of the present disclosure.

FIG. 13 illustrates an exemplary mechanism showing updating of an existing PCF session binding information, in accordance with an embodiment of the present disclosure.

FIG. 14 illustrates an exemplary mechanism showing retrieval of PCF session binding information, in accordance with an embodiment of the present disclosure.

FIG. 15 illustrates an exemplary mechanism showing AF initiated diameter Rx session modification, in accordance with an embodiment of the present disclosure.

FIG. 16 illustrates an exemplary mechanism showing AF initiated diameter Rx session modification, in accordance with an embodiment of the present disclosure.

FIG. 17 illustrates an exemplary mechanism showing PCF initiated diameter Rx session modification, in accordance with an embodiment of the present disclosure.

FIG. 18 illustrates an exemplary mechanism showing AF initiated diameter Rx session termination, in accordance with an embodiment of the present disclosure.

FIG. 19 illustrates an exemplary mechanism showing PCF initiated diameter Rx session termination, in accordance with an embodiment of the present disclosure.

FIG. 20 illustrates a system architecture of a Binding Support Function (BSF), in accordance with an embodiment of the present disclosure.

FIG. 21 illustrates an exemplary computer system in which or with which embodiments of the present disclosure may be implemented.

LIST OF REFERENCE NUMERALS

| | |
|---|---|
| 104 | vprobe |
| 106 | SDL CLI |
| 108 | application CLI |
| 110 | FCAP manager |
| 114 | SM active |
| 122 | SDL |
| 128 | Geo-service manager |
| 130 | Geo-service manager |
| 200 | exemplary deployment architecture |
| 202 | BSF clusters |
| 300 | Exemplary NRF registration |
| 302 | BSF |
| 304 | SCP |
| 306 | NRF |
| 402 | BSF |
| 404 | SCP |
| 406 | NRF |
| 500 | return |
| 502 | BSF |
| 504 | SCP |
| 506 | NRF |
| 600 | exemplary mechanism |
| 602 | BSF |
| 604 | SCP |
| 606 | NRF |
| 700 | exemplary mechanism |
| 702 | BSF |
| 704 | SCP |
| 706 | NRF |
| 800 | exemplary mechanism |
| 802 | BSF |
| 804 | SCP |
| 806 | NRF |
| 900 | exemplary mechanism |
| 902 | BSF |
| 904 | SCP |
| 906 | NRF |
| 1000 | exemplary mechanism |
| 1002 | BSF |
| 1004 | SCP |
| 1100 | exemplary mechanism |
| 1102 | PCF |
| 1104 | BSF |
| 1200 | exemplary mechanism |
| 1202 | PCF |
| 1204 | NSF |
| 1300 | exemplary mechanism |
| 1302 | PCF |
| 1304 | NSF |
| 1400 | exemplary mechanism |
| 1402 | selected PCF |
| 1404 | NRF |
| 1500 | exemplary mechanism |
| 1502 | AF |
| 1504 | DRA |
| 1506 | BSF |
| 1508 | PCF |
| 1600 | exemplary mechanism |
| 1602 | AF |
| 1604 | DRA |
| 1606 | BSF |
| 1608 | PCF |
| 1700 | exemplary mechanism |
| 1702 | AF |
| 1704 | DRA |
| 1706 | BSF |
| 1708 | PCF |
| 1800 | exemplary mechanism |
| 1802 | AF |
| 1804 | DRA |
| 1806 | BSF |
| 1808 | PCF |
| 1900 | exemplary mechanism |
| 1902 | p-CSCF/AF |
| 1904 | DRA |
| 1906 | BSF |
| 1908 | appropriate PCF |
| 2000 | BSF |
| 2002 | receiving module |
| 2004 | sending module |
| 2006 | processing module |
| 2100 | exemplary computer system |
| 2110 | external storage device |
| 2120 | bus |
| 2130 | main memory |
| 2140 | read-only memory |
| 2150 | mass storage device |
| 2170 | processor |

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The disclosure provides a Binding Support Function (BSF) for providing a binding support management service. A Nbsf_Management service is used to provide a Protocol Data Unit (PDU) session binding functionality, which ensures that an application function (AF) request for a certain PDU session reaches a relevant Policy Control Function (PCF) holding the PDU session information. This service allows Network Function (NF) service consumers (e.g., PCF) to register, update and remove binding information and allow a NF service consumer (e.g., the AF, Network Exposure Function (NEF)) to retrieve binding information.

The binding support management service is a 5GC internal service that is used to store information about user identity, data network name, User Equipment (UE) Internet Protocol (IP) address and assigned network slice, for a specific PDU session. This facilitates binding of the PDU session to a relevant PCF.

Hence, for any AF Rx requests, the BSF acts as a proxy to redirect the UE to a selected PCF, based on the IP address of the UE. The BSF allows NF service consumers (e.g., the PCF) to register, update and remove the binding information, and allows NF service consumers (e.g., the AF, the NEF) to discover the binding information (e.g., an address information of the selected PCF).

The BSF is a network entity in a 5G Core Network (5GC) and supports providing functionality such as (a) storing the binding information for a certain PDU session, and (b) enabling discovery of the binding information (e.g., address information of the selected PCF).

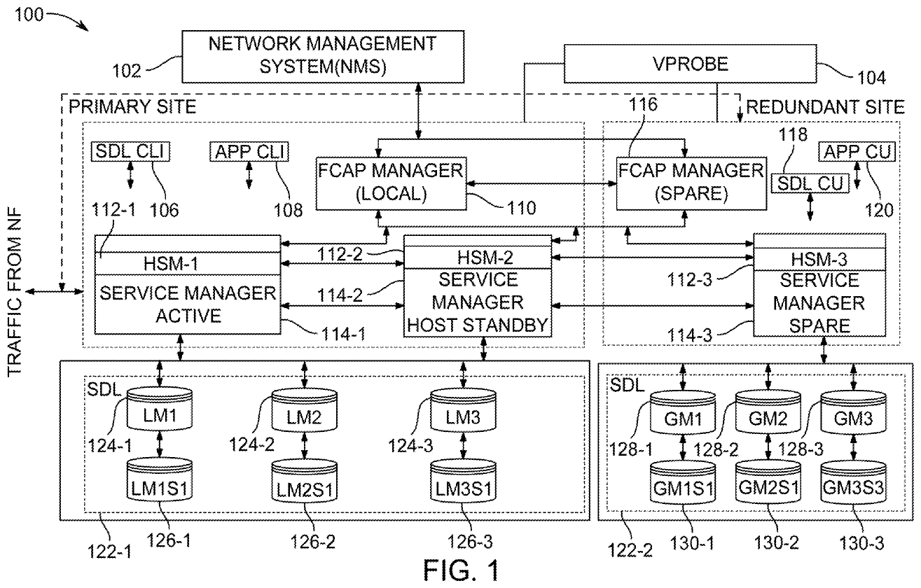

FIG. 1 illustrates an internal cluster architecture (100) of the BSF, in accordance with an embodiment of the present disclosure. The illustrated BSF design (a) has high resilience and is scalable, (b) has no single point of failure which includes node level redundancy, network redundancy as well as geo-redundancy, (c) has minimal latency and packet loss under load condition, (d) enables the BSF to integrate with other network functions for Hyper Text Transfer Protocol2 (HTTP2) based interfaces both directly as well as via Service Communication Proxy(SCP), (e) separates Session Database Layer (SDL) to provide session data across multiple sites for geo-redundancy, and (f) may be deployed in an active, hot standby and spare manner.

Described below in further sections are each of components of the architecture:

One of the components is a Service Manager (SM) (114). The Service Manager (SM) is a main application that serves received requests. The SM is deployed in an active/standby/spare architecture as mentioned below:

The SM active (114-1) is the application that serves requests in a local site.

The SM hot standby (114-2) is the standby application that becomes active when a currently running active instance goes down.

The SM spare (114-3) is the application that runs on a geographical redundant site which becomes active when both the applications running in the local site goes down.

One of main purposes of the SM application are (a) to handle the HTTP2/diameter signalling traffic to/from peer NFs, (b) integration with Fault, Configuration, Accounting, Performance (FCAP) manager application for Network Management System (NMS) (102)/Element Management System (EMS) related functions, (c) connectivity with a Session Database Layer (SDL) (122) for storing and retrieving the NF specific data, (d) interconnectivity with vProbe (104) for transfer of Streaming Data Records (SDR), and (e) provide the Service Management Point (SMP) to serve as Graphical User Interface (GUI) for the NF. In an aspect, the HTTP/2 is the second version of the HTTP protocol. The HTTP/2 is used to enable request and response multiplexing and header compression.

Another component of the architecture is a FCAP manager. The FCAP manager is a micro service that is responsible for providing fault, configuration, accounting and performance management services. This Operation and Management micro service is also responsible for interacting with the NMS. The architecture (100) includes FCAP manager (Local) (110) and FCAP manager (Spare) (116).

Another component of the architecture is the SDL (122). The SDL (122) provides a data node functionality which as the name suggests is used to store session data in a persistent database. The SDL (122) is divided into two sub components—a SDL master node (122-1) and a SDL slave node (122-2). The SDL master node (122-1) is responsible for handling requests for cache from the application. This acts as a level 2 cache for failover. The SDL master node (122-1) includes local manager LM1 (124-1), LM2 (124-2), LM3 (124-3), LM1S1 (126-1), LM2S1 (126-2), LM3S1 (126-3). Further, the SDL slave node (122-2) saves a replicated copy of write requests and handles read requests. The SDL slave node (122-2) includes geo-service manager GM1 (128-1), GM2 (128-2), GM3 (128-3), GM1S1 (130-1), GM2S1 (130-2), GM3S1 (130-3).

Another component of the architecture is a High Availability State Manager (HSM) (112) that is responsible for handling fault tolerance of the cluster. This application collocates with a SM application container. The HSM dictates the active/standby/spare role to be taken by the SM application. The architecture (100) includes HSM-1 (112-1), HSM-2 (112-2) and HSM-3 (112-3).

Another component of the architecture is a Command Line Interface (CLI). The disclosed system provides a separate CLI for managing the application and the SDL. An application CLI (108) manages a command line interface or Multi-modal Mark-up Language (MML) that is responsible for managing the application. Further, a SDL CLI (106) provides a command line interface for fetching statistics of a session data layer.

In an embodiment are discussed features, services and functions of the BSF architecture. The BSF architecture provides a binding support management service that is a 5GC internal service to store information about user identity, data network name, UE IP address and assigned network slice, for the specific PDU session. This facilitates binding of the PDU session to the relevant PCF. Hence, for any AF Rx requests, the BSF acts as a proxy to redirect the UE to the selected PCF, based on the IP address of the UE. The BSF allows NF service consumers (e.g., the PCF) to register, update and remove the binding information, and allows NF service consumers (e.g., the AF, the NEF) to discover the binding information (e.g., address information of the selected PCF).

Further, the BSF architecture provides BSF management services. The BSF architecture supports agile and efficient micro services as discussed below:

### Nbsf_Management_Register Service Operation

This service operation is used to register the binding information for the UE when an IPv4 address and/or an IPv6 prefix is allocated for an IP PDU Session, or a Medium Access Control (MAC) address is used for an Ethernet PDU session.

### Nbsf_Management_Deregister Service Operation

This service operation is used to deregister the binding information for the UE when the PDU session is released.

### Nbsf_Management_Discovery Service Operation

The NEF or the AF uses this service operation to discover a selected PCF.

### Nbsf_Management_Update Service Operation

This service operation allows the NF service consumer to update an existing session binding information for the UE in the BSF by providing information to be updated (e.g., the UE address(es)) for the PDU session, and the BSF updates the session binding information.

Further, the BSF architecture provides a diameter Rx proxy support with the BSF. In proxy mode, when the BSF receives a request from the AF, it may check whether it already has selected a PCF for the Rx session; if it does have the PCF already selected for the Rx session, it may proxy the request to the corresponding PCF. If the BSF does not have the PCF already selected, it shall select the PCF to handle the Rx session and then proxy the request to the selected PCF.

Following services are supported in the proxy mode:
Rx Session Establishment
Rx Session Modification
AF-initiated (subsequent AA Request (AAR))
Rx Session Termination
AF-initiated (Simultaneous transmission and receive (STR))
PCF-initiated Abort-Session-Request (ASR)

Further, the BSF architecture provides a subscriber release on session unavailability. The BSF architecture provides support for custom integration with Unified Data Management (UDM) for detaching of Subscription Permanent Identifier (SUPI). In case of a specific error, codes such as 5065 are either received from the PCF or are generated by the BSF in response to initial AAR received on the Rx interface. The BSF calls a custom API “DeregisterSubscriberFromAMF” supported by a UDM solution using a delete method. This feature may help in ensuring that the subscriber is not stuck in a loop upon unavailability of a session in the PCF or the BSF and the service can be provided to the subscriber automatically by deregistering and reregistering of the subscriber.

Further, the BSF architecture provides a redirect BSF support. In the redirect mode, the BSF may act like a diameter redirect agent and it may send the route information to the requesting node. The AF may contact the BSF on Rx session establishment to retrieve the PCF address. As the BSF (redirect) does not maintain diameter sessions, therefore, the AF should not send the Rx session modification or termination request to the BSF.

Further, the BSF architecture provides a session clean-up. The BSF performs necessary session clean-ups based on the PCF and timing attributes. Clean up procedure applied is based on a configurable timer i.e., “wait time for session termination request.”

Further, the BSF architecture provides a BSF-NRF services integration. The BSF may register or deregister its profile, list of exposed services and parameters in the NRF. The BSF instances may be replaced or updated fully or partially. Any change in state of the BSF instances may be subscribed to in the NRF, which may also be notified by the NRF. A registered BSF may confirm an operative state to the NRF by using a heartbeat function supported by configurable timers.

The BSF architecture provides an Oauth2 authorization support. Generally, the BSF has to use a predefined secret key of access token for validation. There is no requirement for sending validation requests towards NRF for validating the access token. A NF service consumer has to request an Oauth2 access token from an authorization server (e.g., the NRF).

The BSF architecture provides an overload control. The BSF may provide the overload control for the HTTP2 and diameter stack. User defined threshold limits are defined for managing the throttling of sudden burst of traffic in the network.

Further, the BSF architecture provides high availability. The BSF service managers are deployed using an active-standby-spare architecture to provide a high available cluster. A High Availability State Manager (HSM) manages role assignment for an active service manager.

The BSF architecture provides a health check module. For ease of operations, the disclosed system and method supports automatic health check report generation using health check commands in the CLI. In addition, the BSF architecture provides performance management. The disclosed system and method provide a vast array of counters for supported service operations. In addition to the service operation-based success and failure counters, additional counters for latency, NBI, Stack Counters are provided. Further, the BSF architecture supports fault management. The FCAP manager provides multiple alarms, which are based on system function as well as threshold-based alarms. These alarms are transferred to the NMS system for notification. Furthermore, the BSF architecture supports log management. The disclosed system and method provides a capability to change log level for various functions of the NF, e.g., different log levels available at the application level vs the CLI vs replication vs configuration changes etc. Further, logs are maintained for errors generated. Also, an integration with vProbe for sending the SDR is provided. The SDR architecture also provides configuration support via the CLI.

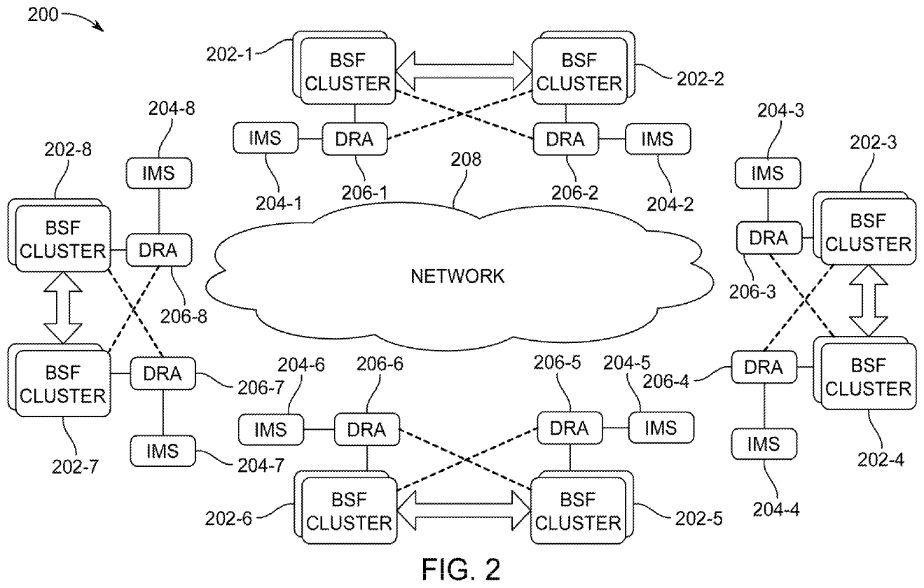

FIG. 2 illustrates an exemplary deployment architecture (200) of a system executed by a processor, in accordance with an embodiment of the present disclosure. As illustrated, the BSF architecture is deployed in multiple core locations in a network (208). Synchronization arrows between mated sites show a synchronization with local and geo service manager deployed at mated site, and not an interaction between different BSF clusters at different super core locations. The deployment architecture (200) includes plurality of BSF clusters (202-1, 202-2, 202-3, 202-4, 202-5, 202-6, 202-7, 202-8), plurality of IP multimedia subsystem (IMS) (204-1, 204-2, 204-3, 204-4, 204-5, 204-6, 204-7, 204-8) and plurality of diameter routing agent (DRA) (206-1, 206-2, 206-3, 206-4, 206-5, 206-6, 206-7, 206-8)

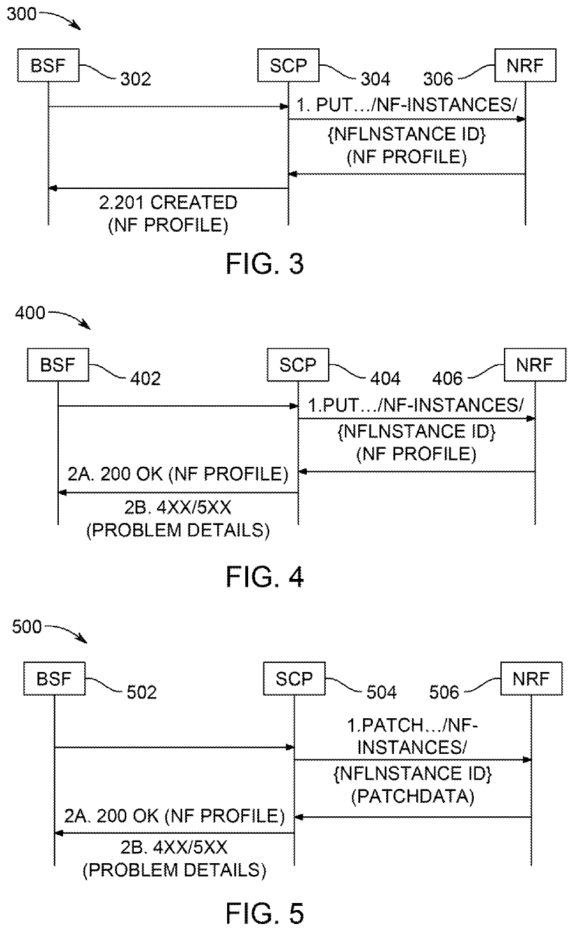

In an embodiment, the disclosed system and method manages an end-to-end call flow for various use cases. FIG. 3 illustrates an exemplary NRF registration (300) for enabling the NF instance to register its NF profile in the NRF (306), in accordance with an embodiment of the present disclosure. As illustrated, the NF instance registers its NF profile in the NRF. This includes registration of general parameters of the NF instance together with a list of services exposed by the NF instance. This service operation is not allowed to be invoked from the NRF in a different Public Land Mobile Network (PLMN). Steps involved for the NF registration are discussed below:

Step 1: A NF service consumer sends a PUT request (e.g., to send data to a server to create/update a resource) to a resource Uniform Resource Identifier (URI) representing the NF Instance. The URI is determined by the NF instance. A variable {nfInstanceID}represents an identifier, provided by the NF service consumer that shall be globally unique inside the PLMN of the NRF where the NF is being registered.

Payload body of the PUT request may contain a representation of the NF instance to be created.

Step 2: On success, “201 Created” may be returned. Payload body of the PUT response may contain representation of a created resource and “Location” header may contain the URI of the created resource. Additionally, the NRF returns a “heart-beat timer” containing a number of seconds expected between two consecutive heart-beat messages from the NF instance to the NRF. Representation of the created resource may be a complete NF profile or a NF profile just including mandatory attributes of the NF profile and the attributes which the NRF added or changed.

If the registration of the NF instance fails at the NRF due to errors in an encoding of a NFProfile JSON object, the NRF may return “400 Bad Request” status code with ProblemDetails IE providing details of the error.

If the registration of the NF instance fails at the NRF due to NRF internal errors, the NRF may return “500 Internal Server Error” status code with the ProblemDetails IE providing details of the error.

During the registration of the NF instance with a custom NF type, the NF instance may provide NF-specific data (in the “customInfo” attribute), that may be stored by the NRF as part of the NF profile of the NF instance. The NRF may accept the registration of the NF instances containing vendor-specific attributes, and therefore, it may accept NF profiles containing attributes whose type may be unknown to the NRF, and those attributes may be stored as part of the NF's profile data in the NRF.

In an embodiment is disclosed a NRF NF update. FIG. 4 illustrates an exemplary mechanism (400), where the NF instance completely updates parameters of the NF profile in the NRF, in accordance with an embodiment of the present disclosure. As illustrated, the NF instance is allowed to replace, or update partially, the parameters of its NF profile (including parameters of associated services) in the NRF. Further, the NF instance also allows to add or delete individual services offered by the NF Instance. This service operation is not allowed to be invoked from the NRF in a different PLMN. To perform a complete replacement of the NF profile of a given NF instance, the NF service consumer may issue an HTTP PUT request.

Step 1: The NF service consumer may send a PUT request to the resource URI representing the NF instance. The payload body of the PUT request may contain a representation of the NF instance to be completely replaced in the NRF.

Step 2a: On success, “200 OK” may be returned, the payload body of the PUT response may contain a representation of a replaced resource. The representation of the replaced resource may be a complete NF Profile or a NF Profile just including mandatory attributes of the NF profile and the attributes which the NRF added or changed.

Step 2b: If the update of the NF instance fails at the NRF due to errors in the encoding of the NFProfile JSON object, the NRF shall return “400 Bad Request” status code with the ProblemDetails IE providing details of the error. If the update of the NF instance fails at the NRF due to NRF internal errors, the NRF shall return “500 Internal Server Error” status code with the ProblemDetails IE providing details of the error.

FIG. 5 illustrates an exemplary mechanism (500) where the NF instance partially updates parameters of the NF profile in the NRF, in accordance with an embodiment of the present disclosure. As illustrated, to perform a partial update of the NF Profile of a given NF Instance, the NF Service Consumer shall issue an HTTP PATCH request. This partial update shall be used to add/delete/replace individual parameters of the NF Instance, and also to add/delete/replace any of the services (and their parameters) offered by the NF Instance.

Step 1: The NF service consumer may send a PATCH request to the resource URI representing the NF instance. Payload body of the PATCH request may contain a list of operations (add/delete/replace) to be applied to the NF profile of the NF instance. These operations may be directed to individual parameters of the NF profile or to a list of services (and their parameters) offered by the NF instances. In order to leave the NF profile in a consistent state, all operations specified by the PATCH request body may be executed atomically.

Step 2a: On success, “200 OK” may be returned, the payload body of the PATCH response may contain a representation of a replaced resource.

Step 2b: If the NF instance, identified by the “nfInstanceID,” is not found in a list of registered NF instances in the NRF's database, the NRF may return “404 Not Found” status code with the ProblemDetails IE providing details of the error.

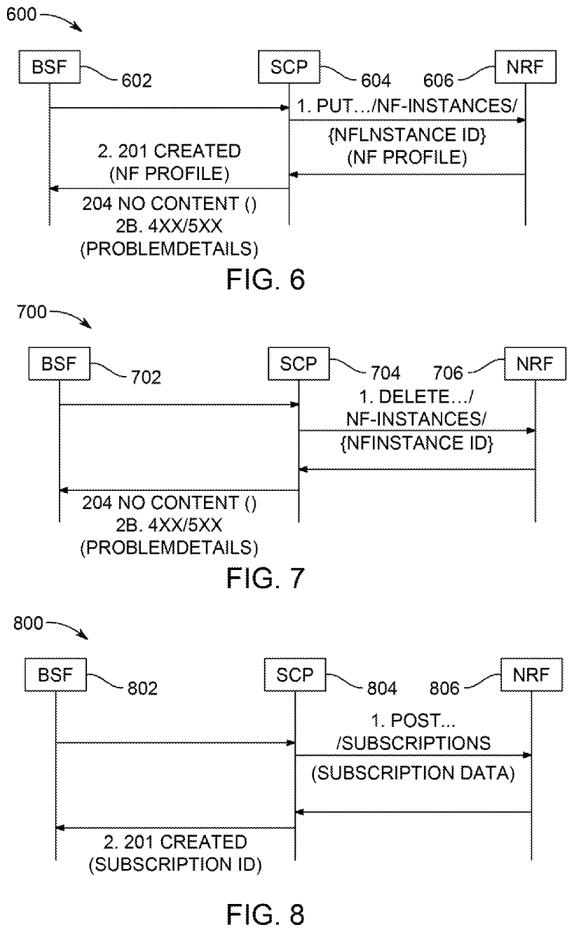

FIG. 6 illustrates an exemplary mechanism (600) showing NF Heart-Beat, in accordance with an embodiment of the present disclosure. Typically, each NF that has previously registered in the NRF (606) may contact the NRF periodically (heart-beat), by invoking the NFUpdate service operation, in order to show that the NF is still operative. A time interval at which the NRF (606) may be contacted is deployment specific, and is returned by the NRF to the NF service consumer as a result of a successful registration.

When the NRF (606) detects that the given NF has not updated its profile for a configurable amount of time (e.g., longer than the heart-beat interval), the NRF (606) may change status of the NF to SUSPENDED. Also, the NF and its services may no longer be discovered by other NFs via a NFDiscovery service. The NRF may notify the NFs that are subscribed to receiving notifications of changes of the NF Profile, that the NF status has been changed to SUSPENDED.

Step 1: The NF service consumer may send a PATCH request to the resource URI representing the NF Instance. Payload body of the PATCH request may contain a “replace” operation on “nfStatus” attribute of the NF profile of the NF instance, and its value is set to being either “REGISTERED” or “UNDISCOVERABLE”.

In addition, a NF service consumer may also provide load information of the NF, and/or the load information of the NF associated NF services. Provision of providing the load information may be limited by the NF via an appropriate configuration (e.g., granularity threshold) in order to avoid notifying minor load changes.

Step 2a: On success, the NRF (606) may return “204 No Content”. The NRF may also answer with “200 OK” along with a full NF profile, e.g., in cases where the NRF determines that the NF profile has changed significantly since the last heart-beat and wants to send a new profile to the NF service consumer.

Step 2b: If the NF instance, identified by the “nfInstanceID,” is not found in the list of registered NF instances in the NRF's database, the NRF may return “404 Not Found” status code with ProblemDetails IE providing details of the error.

FIG. 7 illustrates an exemplary mechanism (700) showing how service operation removes a profile of the NF previously registered in the NRF (706), in accordance with an embodiment of the present disclosure. As illustrated, the service operation may remove the profile of the NF previously registered in the NRF. This is executed by deleting a given resource identified by a “NF Instance ID”. The operation is invoked by issuing a DELETE request on the URI representing the specific NF Instance.

Step 1: The NF Service Consumer may send a DELETE request to the resource URI representing the NF Instance (NRF). The request body shall be empty.

Step 2a: On success, “204 No Content” may be returned. The response body may be empty.

Step 2b: If the NF Instance, identified by the “InstanceID,” is not found in the list of registered NF Instances in the NRF's database, the NRF may return “404 Not Found” status code with the ProblemDetails IE providing details of the error.

FIG. 8 illustrates an exemplary mechanism (800) showing NFStatusSubscribe, in accordance with an embodiment of the present disclosure. The NFStatusSubscribe may allow the NF instance to subscribe to changes on the status of the NF instances registered in the NRF (806). This service operation may be invoked by the NF Instance in a different PLMN (via the local NRF in that PLMN).

Step 1: The NF Service Consumer may send a POST request to the resource URI representing the “subscriptions” collection resource. The request body may include the data indicating the type of notifications that the NF Service Consumer is interested in receiving; it also contains a callback URI, where the NF Service Consumer shall be prepared to receive the actual notification from the NRF and it may contain a validity time, suggested by the NF Service Consumer, representing the time span during which the subscription is desired to be kept active. The subscription request may also include additional parameters indicating the list of attributes in the NF Profile to be monitored, in order to determine whether a notification from NRF (806) should be sent, or not, when any of those attributes is changed in the profile.

Step 2a: On success, “201 Created” shall be returned. The response shall contain the data related to the created subscription, including the validity time, as determined by the NRF (806), after which the subscription becomes invalid. Once the subscription expires, if the NF Service Consumer wants to keep receiving status notifications, it shall create a new subscription in the NRF.

Step 2b: If the creation of the subscription fails at the NRF due to errors in the SubscriptionData JSON object in the request body, the NRF shall return “400 Bad Request” status code with the ProblemDetails IE providing details of the error.

If the creation of the subscription fails at the NRF due to NRF internal errors, the NRF shall return “500 Internal Server Error” status code with the ProblemDetails IE providing details of the error.

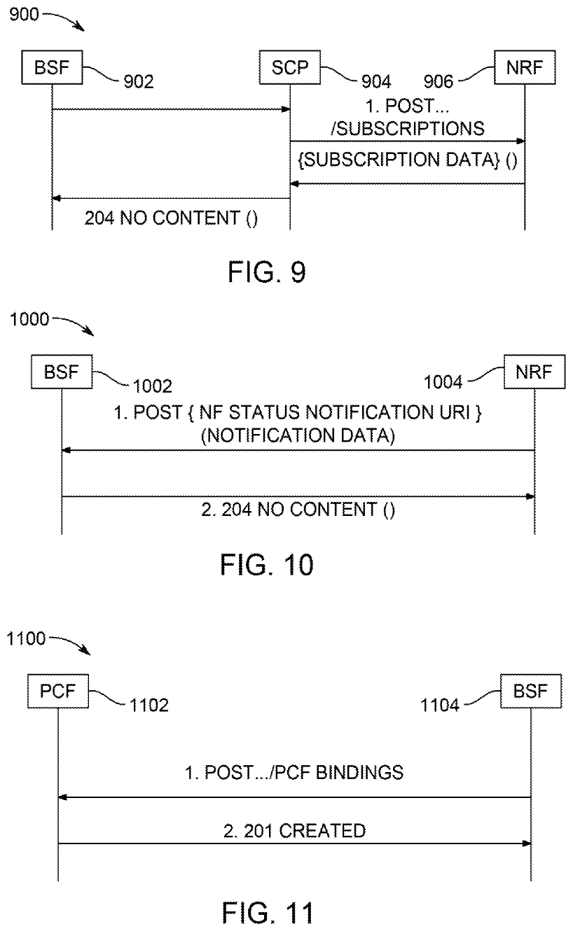

FIG. 9 illustrates an exemplary mechanism (900) showing NF StatusUnSubscribe, in accordance with an embodiment of the present disclosure. NFStatusUnSubscribe allows an NF Instance to unsubscribe to changes on the status of NF Instances Registered in NRF. This service operation can be invoked by an NF Instance in a different PLMN (via the local NRF in that PLMN).

Step 1: The NF Service Consumer may send a DELETE request to the resource URI representing the individual subscription. The request body shall be empty.

Step 2: On success, “204 No Content” may be returned. The response body shall be empty. If the subscription, identified by the “subscriptionID,” is not found in the list of active subscriptions in the NRF's database, the NRF shall return “404 Not Found” status code with the ProblemDetails IE providing details of the error.

FIG. 10 illustrates an exemplary mechanism (1000) showing NFStatusNotify, in accordance with an embodiment of the present disclosure. The NFStatusNotify allows the NRF to notify subscribed NF Instances of changes on the status of NF Instances. This service operation can be invoked by an NF Instance in a different PLMN (via the local NRF in that PLMN).

Step 1: The NRF may send a POST request to the callback URI.

For notifications of newly registered NF Instances, the request body may include the data associated to newly registered NF, and its services, according to the criteria indicated by the NF Service Consumer during the subscription operation. These data may contain the NFInstanceID of the NF Instance, an indication of the event being notified (“registration”), and the new profile data (including, among others, the services offered by the NF Instance).

For notifications of changes of the profile of a NF Instance, the request body shall include the NFInstanceID of the NF Instance whose profile was changed, an indication of the event being notified (“profile change”), and the new profile data.

For notifications of deregistration of the NF Instance from NRF, the request body shall include the NFInstanceID of the deregistered NF Instance, and an indication of the event being notified (“deregistration”).

Step 2: On success, “204 No content” may be returned by the NF Service Consumer. If the NF Service Consumer does not consider the “nfStatusNotificationUri” as a valid notification URI (e.g., because the URI does not belong to any of the existing subscriptions created by the NF Service Consumer in the NRF), the NF Service Consumer shall return “404 Not Found” status code with the ProblemDetails.

FIG. 11 illustrates an exemplary mechanism (1100) showing registration of a new PCF session binding information, in accordance with an embodiment of the present disclosure. The Nbsf_Management_Register service operation allows a NF service consumer (e.g., PCF) (1102) to register the session binding information for a UE in the BSF by providing the user identity, the DNN, the UE address(es) and the selected PCF address for a certain PDU Session to the BSF (1104), and BSF stores the information.

Step 1: The NF service consumer shall invoke the Nbsf_Management_Register service operation to register the session binding information for a UE in the BSF.

Step 2: The BSF created an “Individual PCF Session Binding” resource, the BSF shall respond with “201 Created” status code with the message body containing a representation of the created binding information.

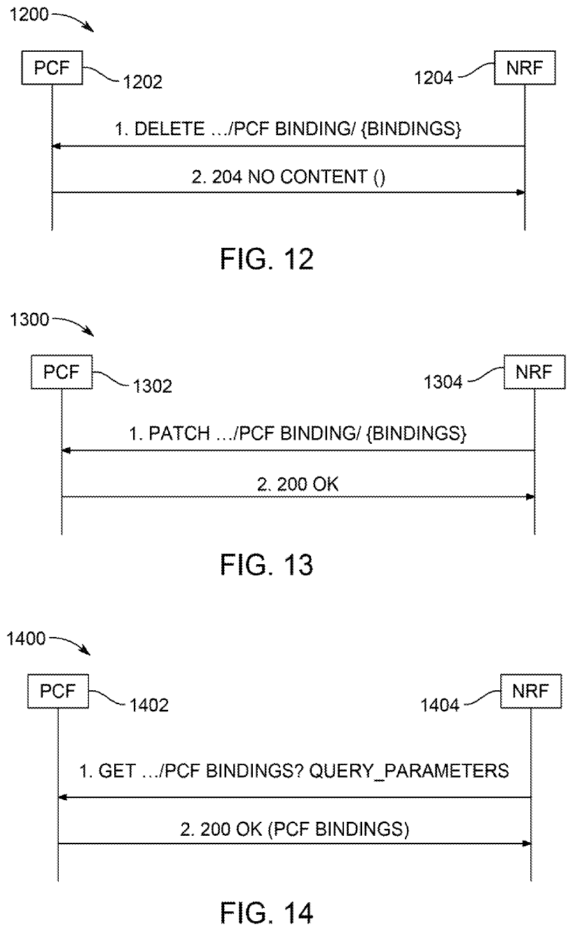

FIG. 12 illustrates an exemplary mechanism (1200) showing deregistering of an individual PCF session binding information, in accordance with an embodiment of the present disclosure.

The Nbsf_Management_Deregister service operation allows the service consumer to remove the session binding information for a UE in the BSF. It is executed by deleting a given resource identified by an Individual PCF Session Binding resource identifier. The operation is invoked by issuing an HTTP DELETE request on the URI representing the specific session binding information.

Step 1: The NF service consumer shall invoke the Nbsf_Management_Deregister service operation to deregister the session binding information for a UE in the BSF

Step 2: If the HTTP DELETE request message from the NF service consumer is accepted, the BSF shall respond with “204 No Content” status code. If the Individual PCF Session Binding resource does not exist, the BSF shall respond with “404 Not Found” error code.

FIG. 13 illustrates an exemplary mechanism (1300) showing updating of an existing PCF session binding information, in accordance with an embodiment of the present disclosure.

The Nbsf_Management_Update service operation allows the NF service consumer to update an existing session binding information for a UE in the BSF by providing information to be updated (e.g., the UE address(es)) for a PDU Session, and BSF updates the session binding information.

Step 1: The NF service consumer shall invoke the Nbsf_Management_Update service operation to update the session binding information for a UE in the BSF.

Step 2: If the BSF successfully updated an “Individual PCF Session Binding” resource, the BSF shall respond with “200 OK” status code with the message body containing a representation of the updated session binding information in the “PcfBindingPatch” data structure.

FIG. 14 illustrates an exemplary mechanism (1400) showing retrieval of PCF session binding information, in accordance with an embodiment of the present disclosure.

The Nbsf_Management_Discovery service operation allows the service consumer to use the HTTP GET method to obtain the address information of the selected PCF (1402).

Step 1: The NF service consumer shall invoke the Nbsf_Management_Discovery service operation to obtain address information of the selected PCF for a PDU session in the BSF. Query parameters shall include UE address, SUPI/GPSI, DNN and optionally S-NSSAI, IPv4 address domain.

Step 2: If the HTTP request message from the NF service consumer is accepted and a session binding resource matching the query parameters exists, the BSF shall reply with an HTTP “200 OK” response and containing the corresponding “PcfBinding” data structure, as provided by the PCF during the Nbsf_Management_Register Service Operation, in the response body containing PCF addressing information, and if available, the related PCF Set Id and PCF instance Id. If there is no PCF session binding information matching the query parameters, the BSF shall respond with an HTTP “204 No Content”.

In an aspect, a NF service consumer (e.g. PCF for a PDU session) may register session binding information for a UE in the BSF by providing the user identity, the DNN, the UE address(es) and the selected PCF address for a certain PDU Session to the BSF. The BSF stores the session binding information for the PDU session.

When the NF service consumer (e.g. PCF for a PDU session) receives a new UE address (e.g., IPv6 prefix) but has already registered session binding information for this PDU session, then the NF service consumer (e.g. PCF for a PDU session) may register a new session binding information in the BSF.

If the SamePcf feature or the ExtendedSamePcf feature is supported, the NF service consumer (e.g. PCF for a PDU session) may check whether PCF addressing information for Npcf_SMPolicyControl service is already registered in the BSF by another PCF for a combination of the UE ID, DNN and S-NSSAI parameters of the PDU session.

This allows the NF service consumer (e.g. PCF for a UE) to register PCF for a UE binding information for a UE in the BSF, by providing to the BSF the user identity and the selected PCF address for a certain UE, and the BSF stores the binding information.

Using the Nbsf_Management_Registration service operation, a new PCF is registered for a PDU session binding information and a new PCF is registered for a UE binding information. The BSF stores the binding information as a resource (e.g., session binding resource). The session binding resource is identified by uniform resource identifier (URI). The URI may represent the “PCF for a PDU session bindings that create a binding information for an “Individual PCF for a PDU Session Binding” according to the information (e.g. UE address(es), SUPI, GPSI, DNN, S-NSSAI).

In an aspect, NF service consumer may retrieve the PCF binding information for a PDU session. The NF service consumer perform the Nbsf_Management_Discovery service operation to obtain address information of the selected PCF for a PDU session in the BSF. The NF service consumer may send an HTTP GET request with “{apiRoot}/nbsf-management/vl/pcfBindings” as Resource URI and query parameters. The query parameters include UE address, SUPI or GPSI, DNN and S-NSSAI, and IPv4 address domain.

Upon the reception of an HTTP GET request with: {apiRoot}/nbsf-management/vl/pcfBindings” as Resource URI, the BSF may search the corresponding binding information by matching query parameters. For example, if “ipv6Prefix” is used as a UE IPv6 address in the query parameters, the BSF may use the longest prefix match to find a matching IPv6 prefix. The IPv6 address in the query parameters is within the address range covered by that matching IPv6 prefix. The IPv6 address in the query parameters are formatted as an IPv6 prefix value including the trailing prefix length “/128”. When the binding information consisting of framed routes, the BSF may use framed routes to match the UE address in the query parameters. In frame routing, 5G network has an ability to provide connectivity from external N6 networks to IP networks for the UE (e.g., UE a router or a customer premises equipment (CPE)). Another IP subnet is associated with the UE alongside the normal IP address that is assigned from the UE IP pool. When one of the query parameters is matched with one of parameter included in the session binding resource, a response message containing the binding information is sent to the PCF.

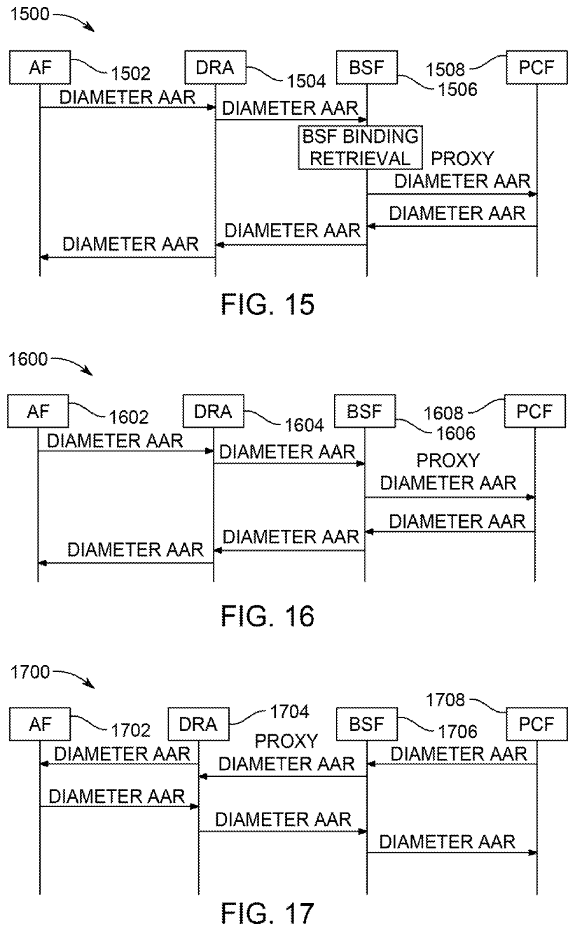

FIG. 15 illustrates an exemplary mechanism (1500) showing AF initiated diameter Rx session modification, in accordance with an embodiment of the present disclosure.

Step 1: The AF (1502) may send a diameter authorization authentication request (AAR) to a diameter routing agent (DRA) (1504).

Step 2: The DRA (1504) may send the diameter AAR to a binding support function (BSF) (1506).

Step 3: The BSF (1506) may perform binding retrieval.

Step 4: The BSF (1506) may send proxy diameter AAR to the PCF (1508).

Step 5: The PCF (1508) may send diameter AAR to the BSF (1506).

Step 6: The BSF (1506) may send diameter AAR to the DRA (1504).

Step 7: The DRA (1504) may send diameter AAR to the AF (1502).

FIG. 16 illustrates an exemplary mechanism (1600) showing AF initiated diameter Rx session modification, in accordance with an embodiment of the present disclosure.

Step 1: The AF (1602) may send a diameter authorization authentication request (AAR) to a diameter routing agent (DRA) (1604).

Step 2: The DRA (1604) may send the diameter AAR to a binding support function (BSF) (1606).

Step 3: The BSF (1606) may send proxy diameter AAR to the PCF (1608).

Step 4: The PCF (1608) may send diameter AAR to the BSF (1606).

Step 5: The BSF (1606) may send diameter AAR to the DRA (1604).

Step 6: The DRA (1604) may send diameter AAR to the AF (1602).

FIG. 17 illustrates an exemplary mechanism (1700) showing PCF initiated diameter Rx session modification, in accordance with an embodiment of the present disclosure.

Step 1: The PCF (1708) may send a diameter authorization authentication request (AAR) to a binding support function (BSF) (1706).

Step 2: The BSF (1706) may send a proxy diameter AAR to a DRA (1704).

Step 3: The DRA (1704) may send diameter AAR to the AF (1702).

Step 4: The AF (1702) may send diameter AAR to the DRA (1704).

Step 5: The DRA (1704) may send diameter AAR to the BSF (1706).

Step 6: The BSF (1706) may send diameter AAR to the PCF (1708).

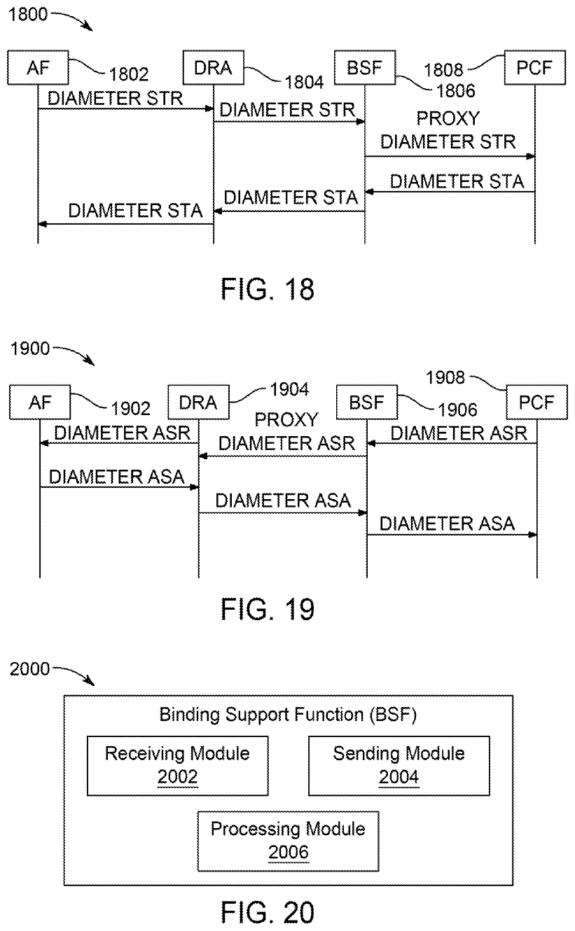

FIG. 18 illustrates an exemplary mechanism (1800) showing AF initiated diameter Rx session termination, in accordance with an embodiment of the present disclosure.

Step 1: The AF (1802) may send a diameter session termination request (STR) to a DRA (1804).

Step 2: The DRA (1804) may send the diameter STR to the BSF (1806).

Step 3: The BSF (1806) may send a proxy diameter STR to the PCF (1808).

Step 4: The PCF (1808) may send a diameter session termination answer (STA) to the BSF (1806).

Step 5: The BSF (1806) may send the diameter STA to the DRA (1804).

Step 6: The DRA (1804) may send the diameter STA to the AF (1802).

FIG. 19 illustrates an exemplary mechanism (1900) showing PCF initiated diameter Rx session termination, in accordance with an embodiment of the present disclosure.

P-CSCF/AF (1902) may need to send the Rx messages to BSF containing the PCF binding information. P-CSCF/AF can use DRA (1904) for same or can use NRF for discovery. Once PCF forwards the message to correct BSF, BSF (1906) will check its internal database for finding the binding information and from the same shall retrieve PCF instance ID. Based on same BSF shall proxy the Rx message towards appropriate PCF (1908).

The NRF is a key component of the 5G Core Network. NRF is the central repository containing information of all Network Functions (NFs) and serves as point of contact for all other Network Functions for retrieving information about other NFs.

The NRF supports following key functions:

Supports service discovery function. Receive NF Discovery Request from NF instance and provides the information of the discovered NF instances (be discovered) to the NF instance.

Maintains the NF profile of available NF instances and their supported services.

Network Function (NF) Repository Function (NRF) is the network entity in the 5G Core Network (5GC) supporting the following functionality:

Maintains the NF profile of available NF instances and their supported services.

Maintains the SCP profile of available SCP instances.

Allows other NF or SCP instances to subscribe to, and get notified about, the registration in NRF of new NF instances of a given type. It also allows SCP instances to subscribe to, and get notified about, the registration in NRF of new SCP instances.

Supports service discovery function. It receives NF Discovery Requests from NF or SCP instances and provides the information of the available NF instances fulfilling certain criteria (e.g., supporting a given service).

Therefore, the disclosed system and method facilitates to provide a BSF that is a network entity in the 5GC and supports storing binding information for a certain PDU session and enabling discovery of binding information (e.g., the address information of the selected PCF).

FIG. 20 illustrates a system architecture of a Binding Support Function (BSF) (2000), in accordance with an embodiment of the present disclosure. The BSF (2000) comprising of a receiving module (2002), a sending module (2004) and a processing module (2006). The receiving module (2002) configured to receive a binding information of a packet data unit (PDU) session for a user equipment (UE) from a policy control function (PCF). The binding information includes at least one of a user identity, a data network name (DNN), a user equipment (UE) internet protocol (IP) address, network slice for the PDU session. The processing module (2006) configured to create a PCF session binding resource to store the binding information of the PDU session for the UE. The sending module (2004) configured to send a response message having a representation of the created binding information to the PCF. The processing module (2006) configured to enable discovery of binding information. The receiving module (2002) configured to receive a hypertext transfer protocol (http) request message with query parameters from the PCF. The query parameters include at least one of UE address, subscription permanent identifier (SUPI)/generic public subscription identifier (GPSI), data network name (DNN), single-network slice selection assistance information (S-NSSAI), IPv4 address domain. The processing module (2006) configured to match information stored in the session binding resource with at least one of the query parameters. On determining that the query parameters are matched with the session binding resource, the sending module (2004) configured to send a response message containing the binding information to the PCF. On determining that the query parameters are not matched with the session binding resource, the sending module (2004) configured to communicate “no content” message to the PCF.

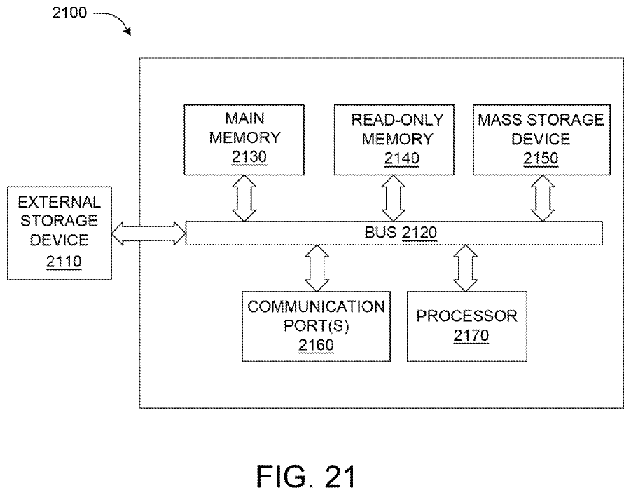

FIG. 21 illustrates an exemplary computer system 2100 in which or with which embodiments of the present disclosure may be implemented. As shown in FIG. 21, the computer system 2100 may include an external storage device 2110, a bus 2120, a main memory 2130, a read-only memory 2140, a mass storage device 2150, communication port(s) 2160, and a processor 2170. A person skilled in the art will appreciate that the computer system 2100 may include more than one processor and communication ports. The processor 2170 may include various modules associated with embodiments of the present disclosure. The communication port(s) 2160 may be any of an RS-232 port for use with a modem based dialup connection, a 10/100 Ethernet port, a Gigabit or 10 Gigabit port using copper or fiber, a serial port, a parallel port, or other existing or future ports. The communication port(s) 2160 may be chosen depending on a network, such a Local Area Network (LAN), Wide Area Network (WAN), or any network to which the computer system 2100 connects. The main memory 2130 may be random access memory (RAM), or any other dynamic storage device commonly known in the art. The read-only memory 2140 may be any static storage device(s) e.g., but not limited to, a Programmable Read Only Memory (PROM) chips for storing static information e.g., start-up or BIOS instructions for the processor 2170. The mass storage device 2150 may be any current or future mass storage solution, which can be used to store information and/or instructions. Exemplary mass storage device 2150 includes, but is not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

The bus 2120 communicatively couples the processor 2170 with the other memory, storage, and communication blocks. The bus 2120 may be, e.g. a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor 2170 to the computer system 2100.

Optionally, operator and administrative interfaces, e.g. a display, keyboard, joystick, and a cursor control device, may also be coupled to the bus 2120 to support direct operator interaction with the computer system 2100. Other operator and administrative interfaces can be provided through network connections connected through the communication port(s) 2160. Components described above are meant only to exemplify various possibilities. In no way should the aforementioned exemplary computer system 2100 limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure supports performing functionalities of a Binding Support Function (BSF).

The present disclosure provides the BSF that stores binding information for a particular Protocol Data Unit (PDU) session and enables discovery of binding information.

The present disclosure provides a BSF design having high resilience and scalability.

The present disclosure provides the BSF such that there is no single point of failure which includes node level redundancy, network redundancy and geo-redundancy.

The present disclosure provides minimal latency and packet loss under load condition in a wireless network. The present disclosure enhances the communication system.

The present disclosure integrates the BSF with other network functions via Hyper Text Transfer Protocol 2 (HTTP2) based interfaces both directly and via a Service Communication Proxy (SCP).

The present disclosure provides a separate Session Database Layer (SDL) to provide session data across multiple sites for geo-redundancy.

The present disclosure deploys the BSF in active, hot standby and spare manner across the wireless network.

We claim:

1. A binding support function (BSF) (2000) for providing binding support management service, the BSF (2000) is configured to:
receive a binding information of a packet data unit (PDU) session for a user equipment (UE) from a policy control function (PCF) (1508), wherein the binding information includes at least one of a user identity, a data network (208) name (DNN), a user equipment (UE) internet protocol (IP) address, network slice for the PDU session;
create a PCF (1508) session binding resource to store the binding information of the PDU session for the UE;
send a response message having a representation of the created binding information to the PCF (1508);
enable discovery of binding information;
receive a hypertext transfer protocol (http) request message with query parameters from the PCF (1508), wherein the query parameters include at least one of UE address, subscription permanent identifier (SUPI)/generic public subscription identifier (GPSI), data network name (DNN), single-network (208) slice selection assistance information (S-NSSAI), and IPv4 address domain;
match information stored in the session binding resource with at least one of the query parameters; and
on determining that the query parameters are matched with the session binding resource, send a response message containing the binding information to the PCF (1508).

2. The BSF (2000) as claimed in claim 1, wherein on determining that the query parameters are not matched with the session binding resource, communicate “no content” message to the PCF (1508).

3. The BSF (2000) as claimed in claim 1, wherein the BSF (2000) is configured to integrate with network (208) functions (NFs) for a hypertext transfer protocol-2 (HTTP2) based interfaces directly or via a service communication proxy (SCP).

4. The BSF (2000) as claimed in claim 1, wherein the BSF (2000) is configured to act as a proxy to redirect the UE to the PCF (1508) based on an internet protocol (IP) address of the UE.

5. The BSF (2000) as claimed in claim 1, wherein plurality of BSF (2000) service managers is deployed using an active/standby/spare architecture to provide a high available cluster.

6. A system for providing binding support management service, the system comprising binding support function (BSF) (2000), wherein the BSF (2000) comprising:
a receiving module (2002) configured to receive a binding information of a packet data unit (PDU) session for a user equipment (UE) from a policy control function (PCF (1508)), wherein the binding information includes at least one of a user identity, a data network name (DNN), a user equipment (UE) internet protocol (IP) address, network slice for the PDU session;
a processing module (2006) configured to create a PCF (1508) session binding resource to store the binding information of the PDU session for the UE;
a sending module (2004) configured to send a response message having a representation of the created binding information to the PCF (1508); and
the processing module (2006) configured to enable discovery of binding information;
the receiving module (2002) configured to receive a hypertext transfer protocol (http) request message with query parameters from the PCF (1508), wherein the query parameters include at least one of UE address, subscription permanent identifier (SUPI)/generic public subscription identifier (GPSI), data network name (DNN), single-network slice selection assistance information (S-NSSAI), IPv4 address domain;
the processing module (2006) configured to match information stored in the session binding resource with at least one of the query parameters; and
on determining that the query parameters are matched with the session binding resource, the sending module (2004) configured to send a response message containing the binding information to the PCF (1508).

7. The system as claimed in the claim 5, wherein on determining that the query parameters are not matched with the session binding resource, the sending module (2004) configured to communicate “no content” message to the PCF (1508).

8. The system as claimed in the claim 5, wherein the BSF (2000) is configured to integrate with network functions (NFs) for a hypertext transfer protocol-2 (HTTP2) based interfaces directly or via a service communication proxy (SCP).

9. The system as claimed in the claim 5, wherein the BSF (2000) is configured to act as a proxy to redirect the UE to the PCF (1508) based on an internet protocol (IP) address of the UE.

10. The system as claimed in the claim 5, wherein plurality of BSF (2000) service managers is deployed using an active/standby/spare architecture to provide a high available cluster.

11. A method for providing binding support management service, the method comprising:
receiving, by a binding support function (BSF (2000)), a binding information of a packet data unit (PDU) session for a user equipment (UE) from a policy control function (PCF) (1508), wherein the binding information includes at least one of a user identity, a data network name (DNN), a user equipment (UE) internet protocol (IP) address, network slice for the PDU session;
creating, by the BSF (2000), a PCF (1508) session binding resource to store the binding information of the PDU session for the UE;
sending, by the BSF (2000), a response message having a representation of the created binding information to the PCF (1508); and
enabling, by the BSF (2000), discovery of the binding information, wherein
receiving, by the BSF (2000), a Hypertext Transfer Protocol (http) request message with query parameters from the PCF (1508), wherein the query parameters include at least one of UE address, subscription permanent identifier (SUPI)/generic public subscription identifier (GPSI), data network name (DNN), single-network slice selection assistance information (S-NSSAI), IPv4 address domain;
matching, by the BSF (2000), information stored in the session binding resource with at least one of the query parameters; and
on determining that the query parameters are matched with the session binding resource, sending, by the BSF (2000), a response message containing the binding information to the PCF (1508).

12. The method as claimed in the claim 9, wherein on determining that the query parameters are not matched with the session binding resource, communicating, by the BSF (2000), “no content” message to the PCF (1508).

13. The method as claimed in the claim 9, wherein the BSF (2000) is configured to integrate with network functions (NFs) for a hypertext transfer protocol-2 (HTTP2) based interfaces directly or via a service communication proxy (SCP).

14. The method claimed as in claim 9, wherein the BSF (2000) is configured to act as a proxy to redirect the UE to the PCF (1508) based on an internet protocol (IP) address of the UE.

15. The method claimed as in claim 9, plurality of BSF (2000) service managers is deployed using an active/standby/spare architecture to provide a high available cluster.

16. A computer program product comprising a non-transitory computer-readable medium comprising instructions that, when executed by one or more processors, cause the one or more processors to execute a method for providing binding support management service, the method comprising:
receiving, by a binding support function (BSF (2000)), a binding information of a packet data unit (PDU) session for a user equipment (UE) from a policy control function (PCF) (1508), wherein the binding information includes at least one of a user identity, a data network name (DNN), a user equipment (UE) internet protocol (IP) address, network slice for the PDU session;
creating, by the BSF (2000), a PCF (1508) session binding resource to store the binding information of the PDU session for the UE;
sending, by the BSF (2000), a response message having a representation of the created binding information to the PCF (1508); and
enabling, by the BSF (2000), discovery of the binding information, wherein
receiving, by the BSF (2000), a Hypertext Transfer Protocol (http) request message with query parameters from the PCF (1508), wherein the query parameters include at least one of UE address, subscription permanent identifier (SUPI)/generic public subscription identifier (GPSI), data network name (DNN), single-network slice selection assistance information (S-NSSAI), IPv4 address domain;
matching, by the BSF (2000), information stored in the session binding resource with at least one of the query parameters; and
on determining that the query parameters are matched with the session binding resource, sending, by the BSF (2000), a response message containing the binding information to the PCF (1508).
